(19) United States
(12) Patent Application Publication
(10) Pub. No.: US 2023/0405861 A1
(43) Pub. Date: Dec. 21, 2023

(54) WORKING MACHINE

(71) Applicant: MAKITA CORPORATION, Anjo-shi (JP)

(72) Inventor: Takuma NIIYAMA, Anjo-shi (JP)

(73) Assignee: MAKITA CORPORATION, Anjo-shi (JP)

(21) Appl. No.: 18/331,480

(22) Filed: Jun. 8, 2023

(30) Foreign Application Priority Data
Jun. 16, 2022 (JP) 2022-097397

(51) Int. Cl. B27B 17/00; B27B 17/12

(52) U.S. Cl. CPC B27B 17/0008; B27B 17/12

(57) ABSTRACT

A working machine may include a working unit having a longitudinal direction in a front-back direction, an electric motor configured to drive the working unit, a control unit configured to control the electric motor, a housing including a housing body and a grip, wherein the housing body holds the working unit and houses the electric motor and the control unit, and the grip extends from the housing body and is configured to be grasped by a user's hand, a battery pack attached to the housing and configured to supply electric power to the electric motor via the control unit, and a trigger lever disposed on the grip and configured to operate the electric motor by being pulled toward the grip by a finger of the user. A front end of the control unit may be disposed rearward of a rear end of the trigger lever.

### REFERENCE TO RELATED APPLICATIONS

This application claims priority from Japanese Patent Application No. 2022-97397 filed on Jun. 16, 2022. The entire content of the priority application is incorporated herein by reference.

### TECHNICAL FIELD

The art disclosed herein relates to working machines.

### BACKGROUND ART

US Patent Application Publication No. 2021/0339420 (US 2021/0339420 A1) describes a working machine including: a working unit having a longitudinal direction in a front-back direction; an electric motor configured to drive the working unit; a control unit configured to control the electric motor; a housing including a housing body and a grip, wherein the housing body holds the working unit and houses the electric motor and the control unit and the grip extends from the housing body and is configured to be grasped by a user's hand; a battery pack attached to the housing and configured to supply electric power to the electric motor via the control unit; and a trigger lever disposed on the grip and configured to operate the electric motor by being pulled toward the grip by a finger of the user. A front end of the control unit is disposed frontward of a front end of the trigger lever.

### DESCRIPTION

In the working machine described in US 2021/0339420 A1, the user may wish to change a posture of the working machine while grasping the grip. At such an occasion, if the posture of the working machine cannot be changed easily for the user, there is a possibility that the user cannot perform work comfortably. The description herein provides an art configured to improve handling performance of a working machine. In the description herein, “level of ease for a user to change a posture of a working machine” may be termed “handling performance of the working machine”.

A working machine disclosed herein may comprise a working unit having a longitudinal direction in a front-back direction, an electric motor configured to drive the working unit, a control unit configured to control the electric motor, a housing including a housing body and a grip, wherein the housing body holds the working unit and houses the electric motor and the control unit, and the grip extends from the housing body and is configured to be grasped by a user's hand, a battery pack attached to the housing and configured to supply electric power to the electric motor via the control unit, and a trigger lever disposed on the grip and configured to operate the electric motor by being pulled toward the grip by a finger of the user. A front end of the control unit may be disposed rearward of a rear end of the trigger lever.

In view of user safety, the grip which the user grasps is generally disposed at a position distant from the working unit (such as on a rear portion of the working machine). Further, it is also norm that weight of a working unit with respect to the entire working machine is relatively large. Due to this, the working machine is likely to have a heavy object (such as the working unit) placed frontward of the front end of the trigger lever, and moment generated with the front end of the trigger lever as a fulcrum tends to be large. Since an area at or in proximity to the front end of the trigger lever is a portion where the user places finger(s), when the moment generated with the front end of the trigger lever as the fulcrum is large, handling performance of the working machine is decreased. Contrary to this, according to the above configuration, the front end of the control unit having relatively large weight among constituent components of the working machine is disposed rearward of the rear end of the trigger lever. Due to this, the moment generated with the front end of the trigger lever as the fulcrum can be reduced by the weight of the control unit. Thus, the handling performance of the working machine can be improved.

### BRIEF DESCRIPTION OF THE DRAWINGS

FIG. 1 is a perspective view seeing a chainsaw T1 of a first embodiment from front left upper side.

FIG. 2 is a perspective view seeing the chainsaw T1 of the first embodiment from rear right upper side in a state of having a battery pack B1 detached from a battery interface 160.

FIG. 3 is a bottom view of the chainsaw T1 of the first embodiment seen from below.

FIG. 4 is a perspective view seeing the chainsaw T1 of the first embodiment from rear left upper side in a state of having a sprocket cover 18 detached from a housing body 14.

FIG. 5 is a cross-sectional view seeing an internal structure in proximity to a base end of a grip 16 of the chainsaw T1 of the first embodiment seen from the left.

FIG. 6 is a cross-sectional view seeing an internal structure of a housing 4 of the chainsaw T1 of the first embodiment seen from the right.

FIG. 7 is a view seeing an electric motor 64, a motor shaft 80, a cooling fan 82, a transmission mechanism 70, an oil pump 68, a sprocket 26, and a working unit 10 of the chainsaw T1 of the first embodiment from front right upper side.

FIG. 8 is a diagram seeing inside of the housing body 14 of the chainsaw T1 of the first embodiment from the front along a direction perpendicular to an axis line A1 of the motor shaft 80.

FIG. 9 is a perspective view seeing a chainsaw T2 of a second embodiment from the rear right upper side in a state of having a battery pack B2 detached from a battery interface 160.

FIG. 10 is a cross-sectional view seeing an internal structure of a housing 4 of the chainsaw T2 of the second embodiment seen from the right.

FIG. 11 is a perspective view seeing a chainsaw T3 of a third embodiment from the rear right upper side in a state of having a battery pack B3 detached from a battery interface 360.

FIG. 12 is a cross-sectional view seeing an internal structure of a housing 4 of the chainsaw T3 of the third embodiment seen from the right.

FIG. 13 is a perspective view seeing a chainsaw T4 of a fourth embodiment from the rear right upper side in a state of having a battery pack B4 detached from a battery interface 360.

FIG. 14 is a cross-sectional view seeing an internal structure of a housing 4 of the chainsaw T4 of the fourth embodiment seen from the right.

FIG. 15 is a perspective view seeing a chainsaw T1 of a variant from the rear right upper side in a state of having a battery pack B1 detached from a battery interface 160.

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved working machines as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, a center of gravity of the electric motor may be disposed rearward of the rear end of the trigger lever.

The electric motor is also a component with relatively large weight among the constituent components of the working machine. According to the above configuration, a position of gravity center of the electric motor is disposed rearward of the rear end of the trigger lever. Due to this, the moment generated with the front end of the trigger lever as the fulcrum can be reduced by the weight of the electric motor. Thus, the handling performance of the working machine can further be improved.

In one or more embodiments, a front end of the electric motor may be disposed rearward of a front end of the trigger lever.

According to the above configuration, the moment generated with the front end of the trigger lever as the fulcrum can further be reduced by the weight of the electric motor. Thus, the handling performance of the working machine can further be improved.

In one or more embodiments, a front end of the battery pack may be disposed rearward of the rear end of the trigger lever.

The battery pack is also a component with relatively large weight among the constituent components of the working machine. According to the above configuration, the front end of the battery pack is disposed rearward of the rear end of the trigger lever. Due to this, the moment generated with the front end of the trigger lever as the fulcrum can be reduced by the weight of the battery pack. Thus, the handling performance of the working machine can further be improved.

In one or more embodiments, the working machine may further comprise a transmission mechanism housed in the housing body and configured to transmit power from the electric motor to the working unit. A rear end of the transmission mechanism may be disposed rearward of a front end of the trigger lever.

In the working machine, a transmission mechanism (including reduction gear) may be disposed between the electric motor and the working unit. The transmission mechanism is also a component with relatively large weight among the constituent components of the working machine. According to the above configuration, the rear end of the transmission mechanism is disposed rearward of the front end of the trigger lever. Due to this, the moment generated with the front end of the trigger lever as the fulcrum can be reduced by the weight at and in proximity to a rear end of the transmission mechanism. Thus, the handling performance of the working machine can further be improved.

In one or more embodiments, the control unit may comprise a control board configured to control the electric motor and a controller case that houses the control board. The controller case may be constituted of a metal.

In the working machine, metal may be used for the controller case for the purpose of improving cooling efficiency for the control board. Since metal has relatively large specific gravity, when the controller case is constituted of metal, weight of the control unit thereby increases. That is, a position of the control unit becomes a greater affecting factor to the moment generated with the front end of the trigger lever as the fulcrum. According to the above configuration, the controller case is constituted of metal. Due to this, the cooling efficiency for the control board can be improved. Further, according to the above configuration, moment reduction effect achieved by the arrangement of the control unit becomes more prominent. Thus, improving effect for the handling performance of the working machine achieved by the present application becomes more prominent.

In one or more embodiments, the electric motor may be a brushless motor. The control unit may comprise a switching element configured to control current supplied to the electric motor.

Generally, when the electric motor is a brushless motor, a generated quantity of heat in the control unit becomes relatively large by heat generation of a plurality of switching elements. In this case, in order to efficiently cool the control unit, the need to constitute the controller case with metal becomes higher. Further, as discussed above, when the controller case is constituted of metal, the improving effect for the handling performance of the working machine achieved by the present application becomes more prominent. According to the above configuration, since the electric motor is a brushless motor, metal is highly likely used to constitute the controller case. Thus, the improving effect for the handling performance of the working machine achieved by the present application is highly likely achieved more prominently.

In one or more embodiments, the working unit may comprise a guide bar extending in the front-back direction and a saw chain disposed on a periphery of the guide bar and configured to move along the periphery of the guide bar as the electric motor operates. The working machine may work as a chain saw.

According to the above configuration, handling performance of the chainsaw can be improved.

In one or more embodiments, the working machine may further comprise an oil tank attached to the housing body and configured to store lubricating oil for lubricating the saw chain. The oil tank may be arranged at or in proximity to a front end of the housing body.

In the chainsaw, lubricant oil stored in the oil tank may need to be supplied to the saw chain (or guide bar) to lubricate the saw chain. In doing so, when a distance between the oil tank and the saw chain (or guide bar) is large, a supply path of the lubricant oil from the oil tank to the saw chain (or guide bar) becomes longer, and this may lead to a size increase of the working machine. Contrary to this, according to the above configuration, the oil tank is disposed at or in proximity to the front end of the housing body, that is, at or in proximity to the saw chain (or guide bar). Thus, the supply path of the lubricant oil can be designed short, and the working machine can be designed compact.

In one or more embodiments, the electric motor may comprise a stator and a rotor. The working machine may further comprise a motor shaft fixed to the rotor. An axis line of the motor shaft may be disposed on a plane extending along front-back and up-down directions. The control unit may be disposed on the axis line of the motor shaft.

According to the above configuration, the distance between the control unit and the electric motor can be shortened. Due to this, a length of a conductor for electrically connecting the control unit and the electric motor can be set short. Thus, the working machine can be designed compact.

In one or more embodiments, a distance from the axis line to the front end of the control unit may be smaller than a distance from the axis line to the rear end of the control unit.

Generally, the electric motor has a substantially axisymmetric shape with respect to the axis line of the motor shaft. According to the above configuration, a center position of the control unit in the front-back direction can be offset rearward along a radial direction of the axis line. Due to this, in the radial direction of the axis line, the center position of the control unit can be offset rearward with respect to a center position of the electric motor. By configuring as such, the conductor for electrically connecting the control unit and the electric motor can easily be disposed rearward of the electric motor. That is, the position of the conductor relative to the trigger lever can easily be disposed farther rearward. The conductor disposed rearward of the electric motor is disposed rearward of the rear end of the trigger lever. In this case, the moment generated with the front end of the trigger lever as the fulcrum can be reduced by the weight of the conductor. Thus, the handling performance of the working machine can further be improved.

In one or more embodiments, when inside of the housing body is seen from front along a direction perpendicular to the axis line of the motor shaft, the control unit, the electric motor, and the oil tank may be arranged substantially in a line.

According to the above configuration, the housing body can be designed compact along the radial direction of the axis line. That is, the working machine can be designed compact in the radial direction of the axis line.

### FIRST EMBODIMENT

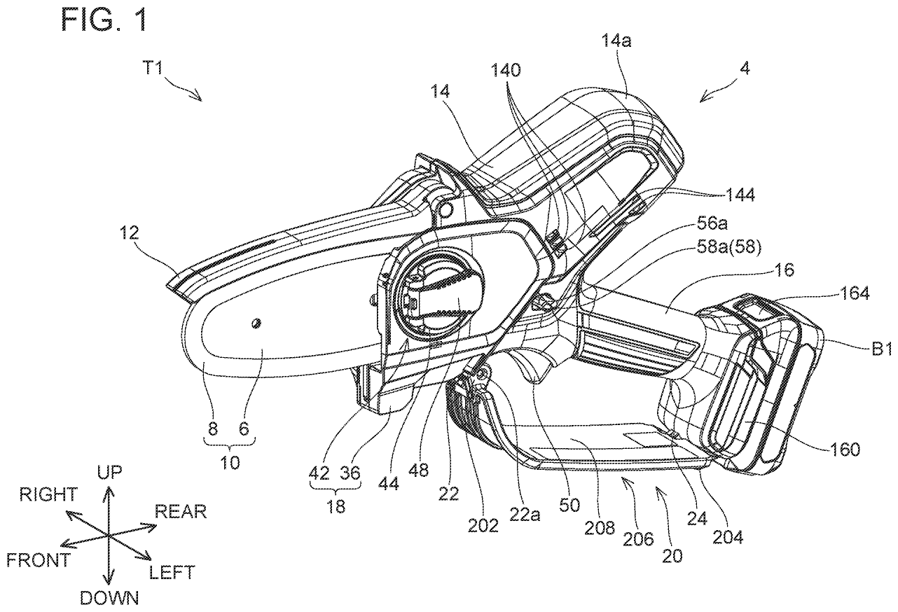

As shown in FIG. 1, a working machine of the present embodiment is a chainsaw T1. The chainsaw T1 is a so-called pruning chainsaw that is primarily used for cutting wood materials and tree branches. An entire weight of the chainsaw T1 is relatively light, as it is about 2000 grams at maximum. Due to this, the chainsaw T1 can be carried by one hand.

The chainsaw T1 comprises a housing 4, a guide bar 6, a saw chain 8, a hand guard and a battery pack B1. The guide bar 6 is a long and narrow plate-shaped member attached to the housing 4 so as to protrude frontward from the housing 4. The guide bar 6 is constituted of metal such as iron. The saw chain 8 includes a plurality of cutters coupled to each other (not shown) and is attached along a periphery of the guide bar 6. The battery pack B1, which is substantially rectangular box shaped, is attached to the housing 4. The chainsaw T1 is configured to run the saw chain 8 along the periphery of the guide bar 6 using electric power supplied from the battery pack B1.

Various types of guide bars may be used as the guide bar 6 depending on the content of cutting work. A curvature radius of a distal end of the guide bar 6 is for example 15 mm. The chainsaw T1 of the present embodiment is configured to run the saw chain 8 along the periphery of the guide bar 6 at a speed of 8 m/s, for example. In the description herein, the guide bar 6 and the saw chain 8 may collectively be termed “working unit 10”. In the present embodiment, weight of the working unit 10 is for example about 180 grams. Further, a work cover 12 that covers a part of the working unit 10 is disposed on the housing 4. Due to this, the user performs cutting work by bringing the portion of the working unit 10 that is not covered by the work cover 12 into contact with an object to be cut (such as a tree branch). In doing so, a load which the user applies to the chainsaw T1 is expected as being about 20N at most.

In the following description, a direction along a longitudinal direction of the guide bar 6 directed toward the guide bar 6 from the housing 4 will be termed a frontward direction, and a direction along the longitudinal direction of the guide bar 6 directed toward the housing 4 from the guide bar 6 will be termed a rearward direction. Further, a direction perpendicular to a front-back direction and directed toward the work cover 12 from the working unit 10 will be termed an upward direction, and a direction perpendicular to the front-back direction and directed toward the working unit 10 from the work cover 12 will be termed a downward direction. Further, a direction perpendicular to the front-back direction and an up-down direction will be termed a left-right direction. In FIGS. 1 to 15, for simplification, the saw chain 8 is depicted as an annular member flush with the guide bar 6.

The housing 4 comprises a housing body 14, a grip 16, a first attachment portion 22, and a second attachment portion 24. The housing body 14 has a substantially rectangular box shape inclined upward from its front portion toward its back portion along the front-back direction. The housing body 14 holds the working unit 10 together with a sprocket cover 18 at its front portion. The grip 16 is connected to a front lower portion of the housing body 14. The grip 16 has a substantially cylindrical shape inclined downward from its front portion toward its back portion along the front-back direction. The first attachment portion 22 is arranged to protrude downward from the housing 4 and is disposed in proximity to a base end of the grip 16. The second attachment portion 24 is arranged to protrude downward from the housing 4 and is disposed in proximity to a distal end of the grip 16. A hand guard 20 is attached to the first attachment portion 22 and the second attachment portion 24. The housing 4 (the housing body 14, the grip 16, the first attachment portion 22, and the second attachment portion 24) uses a material with Young's modulus greater than 100 MPa. The housing 4 of the present embodiment uses plastic such as polyamide. Young's modulus of polyamide is, although it is subject to change by its surrounding environment, at least greater than 5000 MPa. A portion where the fingers of the user's hand are to be placed (a top portion 14a of the housing body 14, the grip 16, and the surrounding thereof) is coated with rubber such as nitrile butadiene rubber.

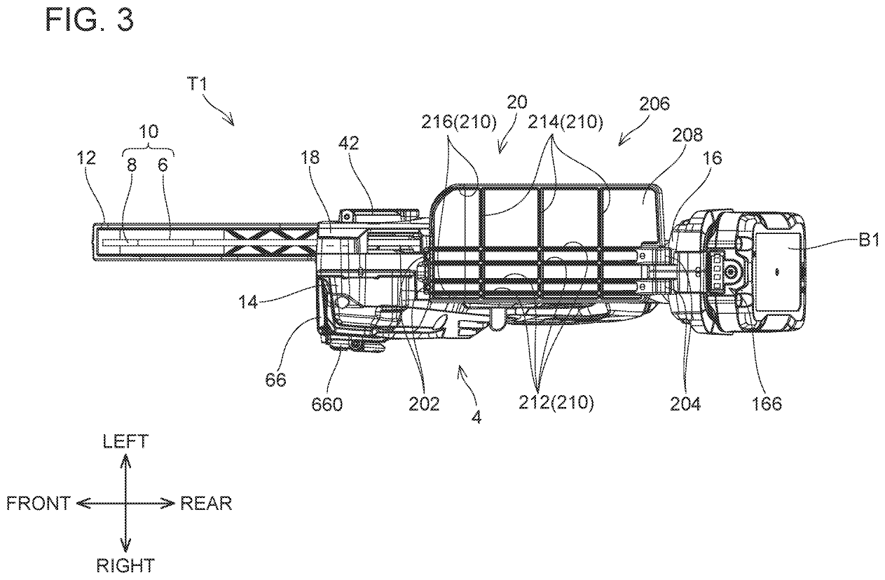

The battery pack B1 houses a rechargeable secondary battery such as a lithium ion battery. An output voltage of the battery pack B1 may for example be 10V. A battery capacity of the battery pack B1 may for example be 1.5 Ah. Weight of the battery pack B1 may for example be about 215 grams. As shown in FIG. 3, an indicator 166 is arranged on a lower surface of the battery pack B1. The indicator 166 notifies the user of remaining charge in the battery pack B1 by changing its display according to the remaining charge of the battery pack B1.

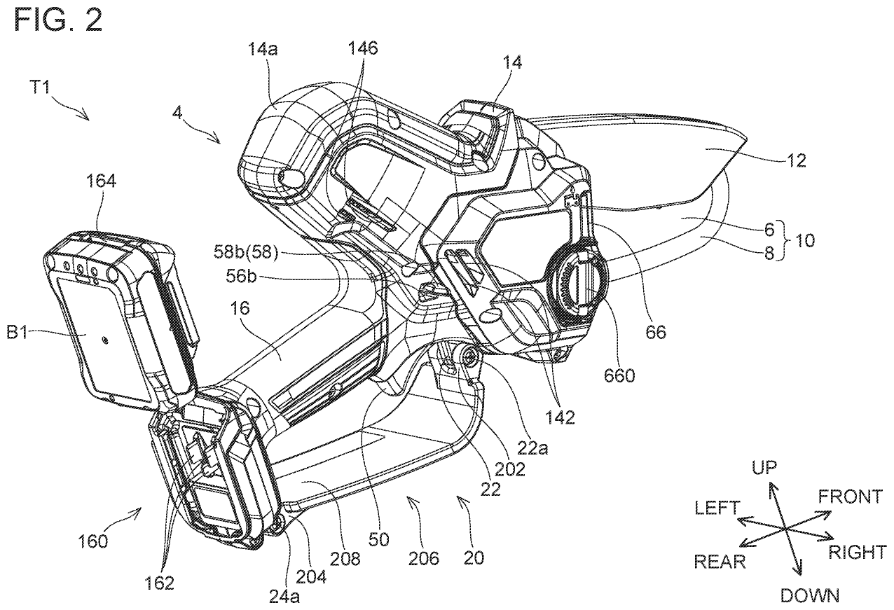

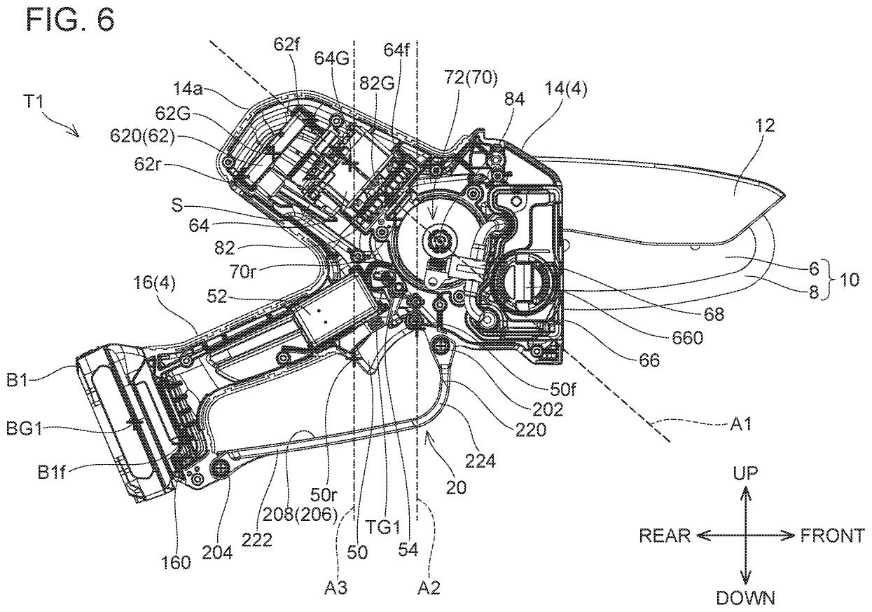

As shown in FIG. 2, the battery interface 160 for detachably receiving the battery pack B1 is arranged at the distal end of the grip 16. The battery pack B1 is attached by sliding it with respect to the battery interface 160 toward front lower side from rear upper side. Further, the battery interface 160 includes a connection terminal 162 for connecting with a terminal (not shown) of the battery pack B1. The connection terminal 162 is electrically connected with a control unit 62 (see FIG. 6) and a trigger switch 52 (see FIG. 6) to be described later. When the battery pack B1 is attached to the battery interface 160, the terminal of the battery pack B1 and the connection terminal 162 are electrically connected. This allows electric power supply from the battery pack B1 to the control unit 62 and the trigger switch 52.

As shown in FIG. 1, when the battery pack B1 is attached to the battery interface 160, outer surfaces of the battery pack B1 and the grip 16 are smoothly connected. Further, the battery pack B1 is detached by sliding it toward the rear upper side from the front lower side with respect to the battery interface 160 with a hook 164 arranged on the battery pack B1 pressed in.

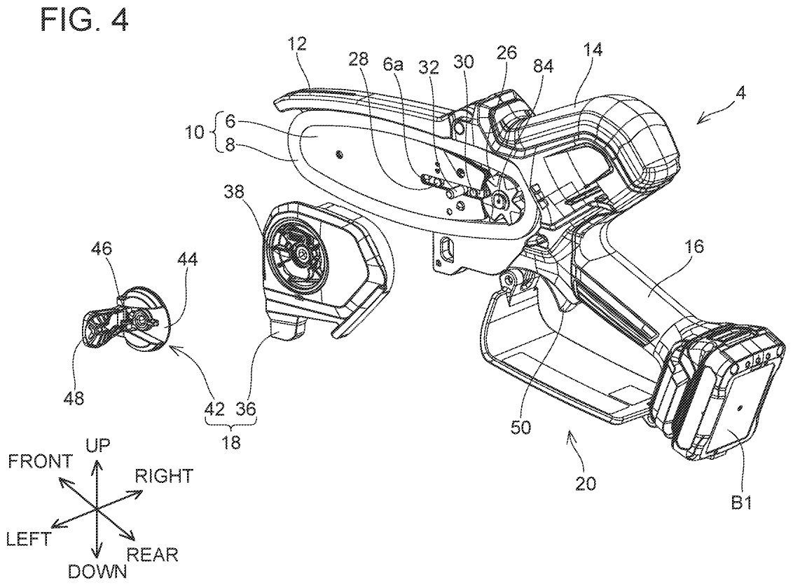

As shown in FIG. 4, the sprocket cover 18 includes a sprocket cover body 36 and an engagement member 42. The sprocket cover body 36 includes a sleeve 38. The engagement member 42 includes an engagement member body 44, a nut 46, and a hook portion 48. The sprocket 26 is exposed to outside of the housing body 14 inside the sprocket cover 18. The saw chain 8 is strapped on the sprocket 26 from the guide bar 6. Further, the guide bar 6 has a cutout 6a extending along the front-back direction defined therein. The cutout 6a has fixed pins 28, 30 protruding from a left side surface of the housing body 14 and a bolt 32 inserted therein from the right.

The sprocket cover 18 can be attached to the housing body 14 by inserting the bolt 32 to the sleeve 38 of the sprocket cover body 36 in the state shown in FIG. 4 and fastening the nut 46 of the engagement member 42 on the bolt 32 penetrating through the sleeve 38. In a state where the nut 46 is fastened to the bolt 32, the guide bar 6 is held and fixed between the housing body 14 and the sprocket cover 18. The user can adjust tension on the saw chain 8 by changing a distance between the guide bar 6 and the sprocket 26 by sliding the guide bar 6 with respect to the housing body 14 in the front-back direction in a state where the bolt 32 and the nut 46 are loosened.

The user can tighten or loosen the bolt 32 and the nut 46 by rotating the hook portion 48 about an axis line of the bolt 32 in a state having the hook portion 48 standing leftward with respect to the engagement member body 44. Due to this, the user can fasten the nut 46 on the bolt 32 with sufficient tightening torque without using a special tool. As shown in FIG. 1, the hook portion 48 under a normal state is held by a torsion spring (not shown) in a state of lying down along the engagement member body 44.

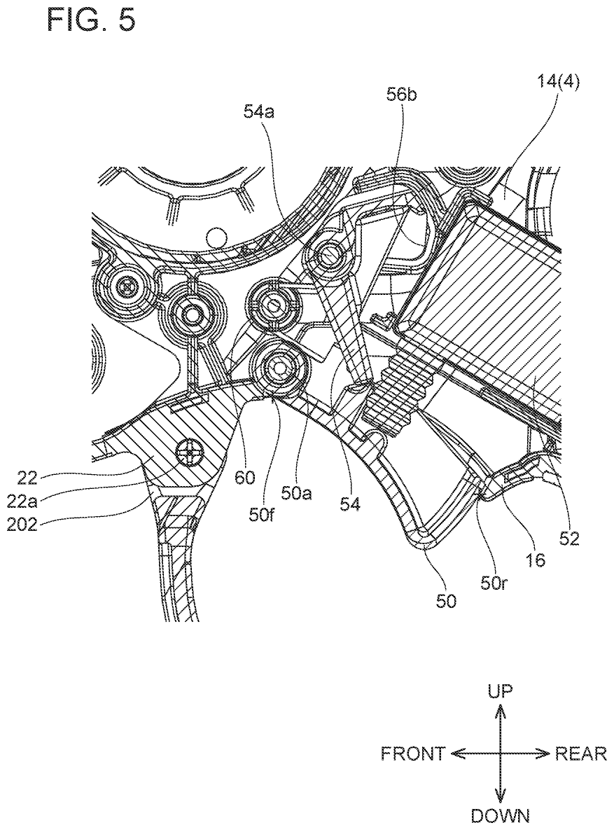

As shown in FIG. 2, the trigger lever 50 for the user to drive and operate the working unit 10 is disposed on a lower surface in proximity to the base end of the grip 16. As shown in FIG. 5, the trigger lever 50 is supported by the housing 4 so as to be rotatable about a rotation axis 50a extending in the left-right direction. The user can operate to pull up the trigger lever toward the grip 16. Further, in the description herein, a front end of a portion of the trigger lever 50 exposed outside the grip 16 will simply be termed “front end 50f”. A rear end of the portion of the trigger lever 50 exposed outside the grip 16 will simply be termed “rear end 50r”.

The trigger switch 52 configured to detect pulling operation performed on the trigger lever 50 by the user is disposed inside the housing 4. The trigger switch 52 is disposed right above the trigger lever 50 and extends between the grip 16 and the housing body 14. The trigger switch 52 is electrically connected to the control unit 62 (see FIG. 6). The trigger switch 52 is configured to output a trigger-on signal to the control unit 62 while the pulling operation is performed on the trigger lever 50. Further, a lock member 54 configured to switch between a state allowing the user to perform operation on the trigger lever 50 and a state prohibiting the user from doing so is further disposed inside the housing 4. The lock member 54 is disposed right above the trigger lever 50 and frontward of the trigger switch 52. The lock member 54 is supported by the housing 4 rotatably about a rotation axis 54a extending in the left-right direction.

In a state where the lock member 54 is rotated up, the lock member 54 mechanically interferes with the trigger lever 50 and upward rotation of the trigger lever 50 is thereby prohibited. In a state where the lock member 54 is rotated down, the lock member 54 no longer interferes with the trigger lever 50 and the upward rotation of the trigger lever 50 is thereby allowed.

As shown in FIG. 1, the lock member 54 includes a left lock lever 58a protruding to the outside of the housing 4 via a through hole 56a defined in a left side surface of the housing 4. As shown in FIG. 2, the lock member 54 includes a right lock lever 58b protruding to the outside of the housing 4 via a through hole 56b defined in a right side surface of the housing 4. Hereinbelow, the left lock lever 58a and the right lock lever 58b may collectively be termed “lock levers 58”. The user can operate to rotate the lock member 54 via the lock levers 58.

The trigger lever 50 and the lock member 54 are coupled to each other by a torsion spring 60 (see FIG. 5). The torsion spring 60 is configured to bias the trigger lever 50 in a direction of rotating downward, and biases the lock member 54 in a direction of rotating upward. Due to this, when the user has his/her hand off the trigger lever 50, the trigger lever 50 is in a state of having rotated down by a biasing force of the torsion spring 60. Further, when the user has his/her hand off the lock levers 58, the lock member 54 is in a state of having rotated up by a biasing force of the torsion spring 60.

For example, when the user uses the chainsaw T1, the user holds the chainsaw T1 by grasping the grip 16 with the right hand and the left hand placed at the top portion 14a. From this state, when the user presses down the lock levers 58 with the right thumb, the user's operation on the trigger lever 50 is thereby allowed, and the working unit 10 is actuated by the user pulling the trigger lever 50 with the right index finger in this state.

(Configuration of Hand Guard 20)

The hand guard 20 shown in FIG. 1 is a protector for protecting the user's hand grasping the grip 16. If the saw chain 8 breaks while the user is performing the cutting work (while driving the working unit 10), the broken saw chain 8 may spin off the guide bar 6 with the driving force still carried thereon. In such a case, the hand guard 20 can suppress the saw chain 8 that spun off the guide bar 6 from contacting the user's hand grasping the grip 16 (see FIG. 1). The hand guard 20 is constituted of a material having Young's modulus within a range from 1 MPa to 100 MPa, for example. The hand guard 20 of the present embodiment is constituted for example of rubber such as nitrile butadiene rubber. Young's modulus of nitrile butadiene rubber can be said as being within the range from 1 MPa to 10 MPa, although it is subject to change by its surrounding environment.

The hand guard 20 includes a first end 202, a second end 204, and a guard body 206 continuously extending between the first end 202 and the second end 204. The first end 202 is attached to the first attachment portion 22 in a state of being rotatable about a rotation axis 22a extending in the left-right direction. By being attached to the first attachment portion 22, the first end 202 is disposed in proximity to the base end of the grip 16. Further, the second end 204 is attached to the second attachment portion 24 in a state of being rotatable about a rotation axis 24a extending in the left-right direction (see FIG. 2). By being attached to the second attachment portion 24, the second end 204 is disposed in proximity to the distal end of the grip 16.

The guard body 206 includes a plate portion 208 having a plate shape and a plurality of rib portions 210 protruding downward from a lower surface of the plate portion 208 (see FIG. 3). The plate portion 208 is disposed such that its upper surface faces the grip 16. In the present embodiment, a thickness of the plate portion 208 (thickness in a direction perpendicular to upper and lower surfaces of the plate portion 208) is for example about 5 mm.

As shown in FIG. 3, when the chainsaw T1 is seen from below, the plate portion 208 has a substantially rectangular shape. The plate portion 208 has a width of about 29 mm on the left side of a left surface of the guide bar 6, for example. The plate portion 208 has a width of about 30 mm on the right side of a right surface of the guide bar 6, for example. Further, the plate portion 208 has a width of about 30 mm on the left side of a left surface of the grip 16, for example (see FIG. 1). The plate portion 208 has a width of about 0.5 mm on the right side of a right surface of the grip 16, for example.

The plurality of rib portions 210 includes first rib portions 212 extending in the front-back direction along the lower surface of the plate portion 208, second rib portions 214 extending in the left-right direction along the lower surface of the plate portion 208, and a third rib portion 216 extending along a peripheral portion on the lower surface of the plate portion 208. There are four first rib portions 212 arranged along the left-right direction. When the chainsaw T1 is seen from below, each of the first rib portions 212 extends substantially straight between the first end 202 and the second end 204. Further, there are three second rib portions 214 arranged along the front-back direction. The first rib portions 212 and the second rib portions 214 are connected at portions that intersect each other. The second rib portions 214 are connected to the third rib portion 216 at their left and right ends.

As shown in FIG. 6, the plate portion 208 comprises a first extending portion 220 extending to separate away from the grip 16 from its base end side toward its distal end side, a second extending portion 222 extending to separate away from the grip 16 from its distal end side toward its base end side, and a bending portion 224 connecting the first extending portion 220 and the second extending portion 222. A length of the first extending portion 220 in its extending direction is shorter than a length of the second extending portion 222 in its extending direction. A bending angle of the bending portion 224 may for example be 100°. A curvature radius of the bending portion 224 may for example be 18 mm. Due to this, in a natural state (state in which external force is not applied to the hand guard 20), the hand guard 20 has a shape protruding outward as seen from the grip 16.

With the hand guard 20 configured as described above, the hand guard 20 is elastically more deformable than the housing 4. The hand guard 20 is configured to start deforming by application of a predetermined load of 5N or less from a direction facing the lower surface of the plate portion 208, for example. “Start deforming” herein means that elastic strain of the hand guard 20 exceeds 1%. Due to this, the user can deform the hand guard 20 with a relatively small load.

(Internal Structure of Chainsaw T1)

As shown in FIG. 6, the control unit 62, an electric motor 64, an oil tank 66, an oil pump 68, a reduction gear 72, and a cooling fan 82 are housed inside the housing body 14.

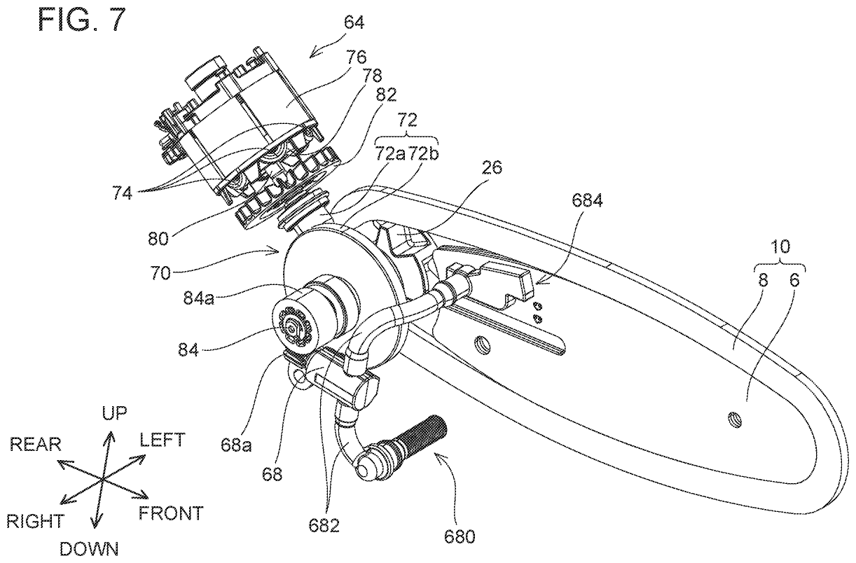

As shown in FIG. 7, the electric motor 64 is an inner rotor DC brushless motor. The electric motor 64 includes a stator 76 on which a coil 74 is wound and a rotor 78 disposed inside the stator 76 and including a permanent magnet (not shown). In the present embodiment, weight of the electric motor 64 (coil 74, stator 76, and rotor 78) is for example about 180 grams. A motor shaft 80 disposed to penetrate through centers of the stator 76 and the rotor 78 is fixed to the rotor 78. Due to this, the electric motor 64 is configured to rotate the motor shaft 80.

The cooling fan 82 is fixed to the motor shaft 80 at a position lower than the rotor 78. The cooling fan 82 rotates accompanying rotation of the motor shaft 80. When the cooling fan 82 rotates, a flow of air directed upward from below is formed along an axis line A1 of the motor shaft 80 (see FIG. 6). At this time, air is suctioned inside from outside the housing 4 through a left air inlet 140 (see FIG. 1) and a right air inlet 142 (see FIG. 2). Further, air is discharged outside from inside the housing 4 through a left air outlet 144 (see FIG. 1) and a right air outlet 146 (see FIG. 2). Due to this, the cooling fan 82 can cool the electric motor 64 accompanying the actuation of the electric motor 64.

The reduction gear 72 includes a first bevel gear 72a fixed to the motor shaft 80 at a position lower than the cooling fan 82 and a second bevel gear 72b meshed with the first bevel gear 72a. The second bevel gear 72b is fixed to the drive shaft 84. The drive shaft 84 is supported by the housing 4 (see FIG. 1) so as to be rotatable about a rotation axis extending in the left-right direction. The sprocket 26 is fixed to the drive shaft 84 on the left side of the second bevel gear 72b. Due to this, when the electric motor 64 is driven, rotary motion of the motor shaft 80 is transmitted to the saw chain 8 through the reduction gear 72, the drive shaft 84, and the sprocket 26. Due to this, the saw chain 8 rotates around the sprocket 26 and the guide bar 6.

The oil tank 66 shown in FIG. 6 is a tank for storing lubricant oil for lubricating the saw chain 8. The oil tank 66 can store up to about 50 cc of lubricant oil. The oil tank 66 has an oil inlet (not shown) for replenishing the lubricant oil in the oil tank 66. The oil inlet has a cap 660 detachably attached thereto. The oil tank 66 is disposed in proximity to a front end of the housing body 14. As shown in FIG. 2, the cap 660 and the oil inlet of the oil tank 66 are exposed to the outside of the housing body 14. Due to this, the user can detach the cap 660 from the oil inlet without disassembling the housing body 14 and fill the oil tank 66.

As shown in FIG. 7, the drive shaft 84 has a worm gear 84a fixed thereto on the right side of the second bevel gear 72b. The worm gear 84a meshes with a worm wheel 68a of the oil pump 68. Due to this, when the electric motor 64 is driven, the rotary motion of the motor shaft 80 is transmitted to the oil pump 68 through the reduction gear 72, the drive shaft 84, the worm gear 84a, and the worm wheel 68a. Due to this, the oil pump 68 is driven. When the oil pump 68 is driven, the lubricant oil is suctioned into an oil supply path 682 through an intake portion 680 disposed inside the oil tank 66 (see FIG. 6). Then, the lubricant oil is supplied from the oil supply path 682 via a discharge portion 684 to the guide bar 6 and the saw chain 8.

In the description herein, a mechanism composed of the reduction gear 72, the drive shaft 84, and the worm gear 84a may be termed “transmission mechanism 70”. As shown in FIG. 6, the transmission mechanism 70 is disposed at a center portion of the housing body 14. The transmission mechanism 70 is disposed on front lower side of the electric motor 64. The transmission mechanism 70 is disposed rearward of the oil tank 66. In the present embodiment, weight of the transmission mechanism 70 is for example about 110 grams.

The control unit 62 is disposed just below the top portion 14a of the housing body 14. The control unit 62 is disposed on upper rear side of the electric motor 64. A wiring space S is defined below the control unit 62 and rearward of the electric motor 64. Although not shown, majority of conductor wires electrically connecting the respective constituent components such as the control unit 62 and the electric motor 64 are arranged through the wiring space S.

The control unit 62 includes a control board (not shown) on which an inverter circuit including a plurality of switching elements and a control circuit configured to control operation of each of those switching elements are mounted, and a controller case 620 that has a substantially rectangular box shape and houses the control board. The controller case 620 is constituted of metal such as aluminum. In the present embodiment, weight of the control unit 62 is about 60 grams.

While the trigger-on signal is outputted from the trigger switch 52, the control unit 62 converts DC power supplied from the battery pack B1 to three-phase AC power and supplies the same to the electric motor 64. When the trigger-on signal is no longer outputted from the trigger switch 52, the control unit 62 cuts off power supply from the battery pack B1 to the electric motor 64. Further, the control unit 62 controls actuation of the electric motor 64 so that the saw chain 8 runs in a predetermined running direction. The predetermined running direction herein refers to a direction along which the saw chain 8 runs frontward above the guide bar 6 and runs rearward below the guide bar 6.

(Positional Relationship of Primary Constituent Components and Axis Line A1)

The axis line A1 of the motor shaft 80 (see FIG. 7) is on a plane spreading along the front-back and up-down directions. The axis line A1 is inclined frontward from the upper side toward the lower side along the up-down direction. An inclination angle of the axis line A1 with respect to the up-down direction is 41° in the present embodiment. The control unit 62 is disposed on the axis line A1. The control unit 62 (controller case 620) is disposed along a plane that is substantially perpendicular to the axis line A1. A distance from the axis line A1 to a front end 62f of the control unit 62 (which coincides a front end of the controller case 620) is smaller than a distance from the axis line A1 to a rear end 62r of the control unit 62 (which coincides a rear end of the controller case 620). Further, the drive shaft 84 of the transmission mechanism 70 is disposed substantially perpendicular to the axis line A1.

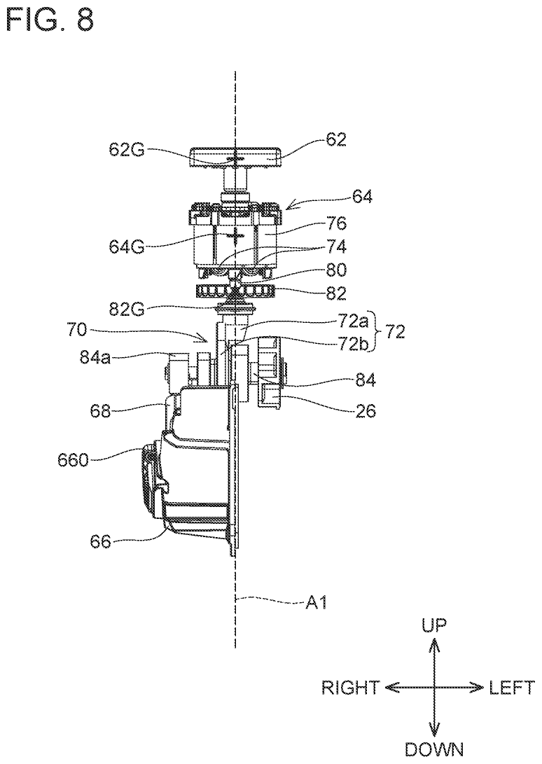

As shown in FIG. 8, when the inside of the housing body 14 (see FIG. 1) is seen from the front along a direction perpendicular to the axis line A1, the control unit 62, the electric motor 64, the cooling fan 82, the transmission mechanism 70 and the sprocket 26, and the oil tank 66 are arranged substantially in a line in this order from the higher side. When seen from the front along the direction perpendicular to the axis line A1, a position of gravity center 62G of the control unit 62, a position of gravity center 64G of the electric motor 64, and a position of gravity center 82G of the cooling fan 82 are respectively disposed on the axis line A1.

When seen from the front along the direction perpendicular to the axis line A1, each of the control unit 62, the electric motor 64, and the cooling fan 82 has a substantially left-right symmetric shape (substantially in linear symmetry with respect to the axis line A1). Although not shown, the grip 16 (see FIG. 1) and the battery pack B1 (see FIG. 1) similarly have substantially left-right symmetric shapes (substantially in linear symmetry with respect to the axis line A1). Further, the sprocket 26 is disposed to the left of the axis line A1. The oil tank 66, the oil pump 68, the second bevel gear 72b, and the worm gear 84a are disposed to the right of the axis line A1.

(Positional Relationship of Primary Constituent Components relative to Trigger Lever 50)

FIG. 6 depicts a straight line A2 extending in the up-down direction through the front end 50f of the trigger lever 50 and a straight line A3 extending in the up-down direction through the rear end 50r of the trigger lever 50.

The front end 62f of the control unit 62 is disposed rearward of the rear end 50r of the trigger lever 50. A front end 64f of the electric motor 64 is disposed rearward of the front end 50f of the trigger lever 50 and frontward of the rear end 50r of the trigger lever 50. A rear end 70r of the transmission mechanism 70 (which coincides a rear end of the first bevel gear 72a) is disposed rearward of the front end 50f of the trigger lever 50 and frontward of the rear end 50r of the trigger lever 50. A front end B1f of the battery pack B1 is disposed rearward of the rear end 50r of the trigger lever 50. Further, the position of gravity center 62G of the control unit 62 is disposed rearward of the rear end 50r of the trigger lever 50. The position of gravity center 64G of the electric motor 64 is disposed rearward of the rear end 50r of the trigger lever 50. The position of gravity center 82G of the cooling fan 82 is disposed rearward of the front end 50f of the trigger lever 50 and frontward of the rear end 50r of the trigger lever 50. A position of gravity center BG1 of the battery pack B1 is disposed rearward of the rear end 50r of the trigger lever 50.

In the chainsaw T1 configured as described above, a position of gravity center TG1 of the chainsaw T1 is disposed inside the housing 4 between the straight lines A2 and A3. The position of gravity center TG1 can be said as being a position overlapped with the lock member 54. Further, a distance from the straight line A2 to the position of gravity center TG1 and a distance from the straight line A3 to the position of gravity center TG1 are configured substantially the same. In the present embodiment, the position of gravity center TG1 is determined under a state in which a full amount of lubricant oil is stored in the oil tank 66, the battery pack B1 is attached to the battery interface 160, and other constituent components are all attached.

### SECOND EMBODIMENT

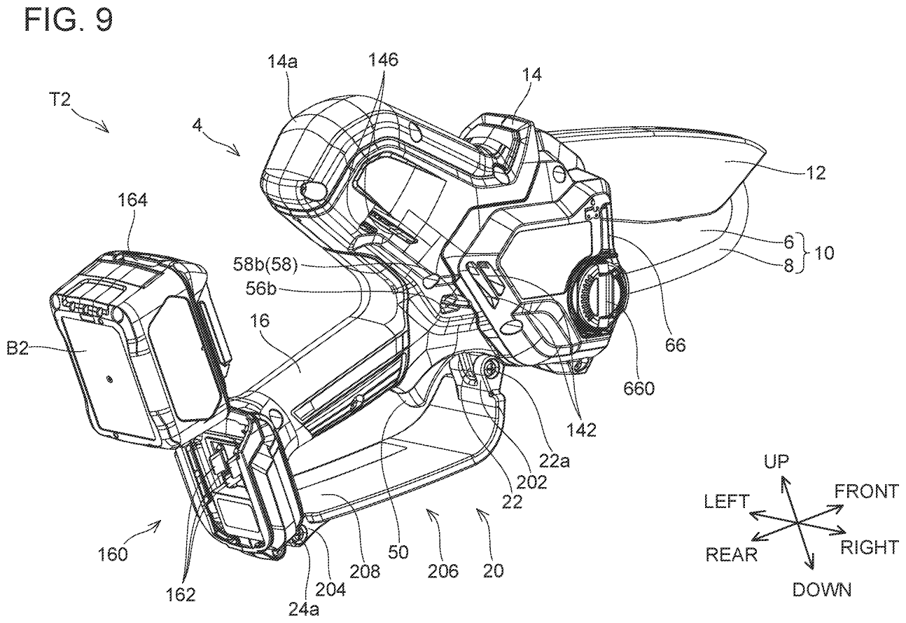

As shown in FIG. 9, a working machine of the present embodiment is a chainsaw T2. The chainsaw T2 has substantially the same configuration as the chainsaw T1 of the first embodiment except that it comprises a battery pack B2 instead of the battery pack B1. Hereinbelow, explanation will be given only on the differences between the chainsaw T2 and the chainsaw T1.

The battery pack B2 houses a rechargeable secondary battery such as a lithium ion battery. An output voltage of the battery pack B2 may for example be 10V. A battery capacity of the battery pack B2 may for example be 4.0 Ah. Weight of the battery pack B2 may for example be about 375 grams. The battery pack B2 is configured to be detachably attached to the battery interface 160 similar to the battery pack B1.

As compared to the battery pack B1 (see FIG. 2), the battery pack B2 has a larger width in the extending direction of the grip 16. A width of the battery pack B2 in the left-right direction is about the same as that of the battery pack B1. A width of the battery pack B2 in a direction perpendicular to the extending direction of the grip 16 and the left-right direction is about the same as that of the battery pack B1. Due to this, a volume of the battery pack B2 is larger than a volume of the battery pack B1.

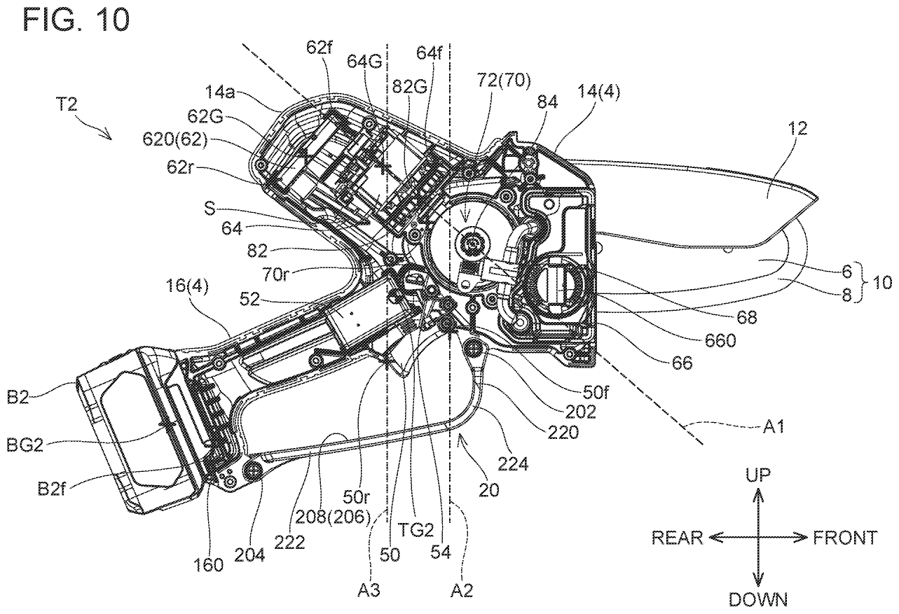

As shown in FIG. 10, a front end B2f and a position of gravity center BG2 of the battery pack B2 are disposed rearward of the rear end 50r of the trigger lever 50. Further, a position of gravity center TG2 of the chainsaw T2 is disposed inside the housing 4 and between the straight lines A2 and A3. The position of gravity center TG2 may be said as being located in proximity to a front end of the trigger switch 52. Further, a distance from the straight line A2 to the position of gravity center TG2 is larger than a distance from the straight line A3 to the position of gravity center TG2.

### THIRD EMBODIMENT

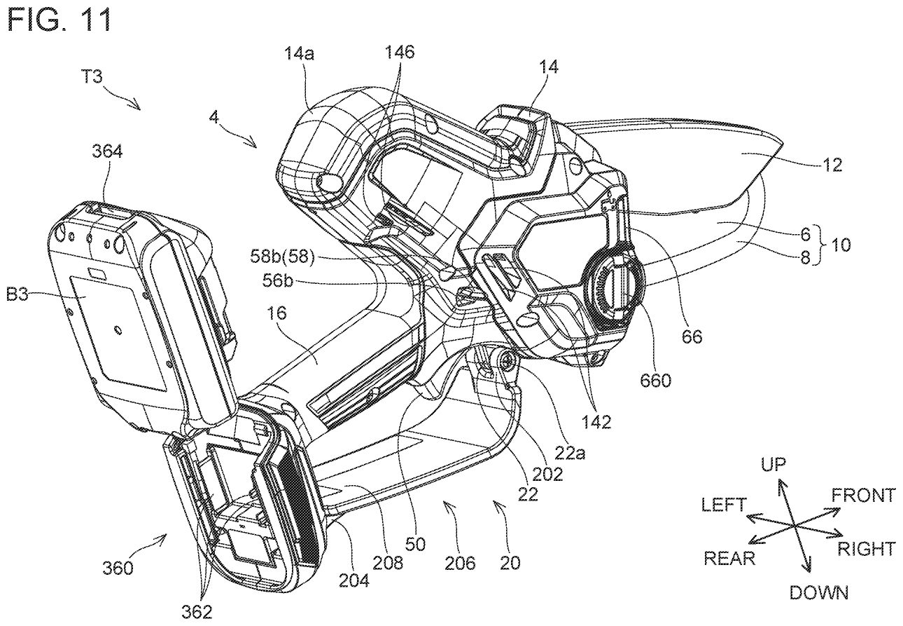

As shown in FIG. 11, a working machine of the present embodiment is a chainsaw T3. The chainsaw T3 has substantially the same configuration as the chainsaw T1 of the first embodiment except that it comprises a battery pack B3 instead of the battery pack B1 and a battery interface 360 instead of the battery interface 160. Hereinbelow, explanation will be given only on the differences between the chainsaw T3 and the chainsaw T1.

The battery pack B3 houses a rechargeable secondary battery such as a lithium ion battery. An output voltage of the battery pack B3 may for example be 18V. A battery capacity of the battery pack B3 may for example be 2.0 Ah. Weight of the battery pack B3 may for example be about 375 grams. A width of the battery pack B3 in the extending direction of the grip 16 is about the same as that of the battery pack B1 (see FIG. 2). As compared to the battery pack B1, the battery pack B3 has a wider width in the left-right direction. As compared to the battery pack B1, the battery pack B3 has a wider width in the direction perpendicular to the extending direction of the grip 16 and the left-right direction. Due to this, a volume of the battery pack B3 is larger than the volume of the battery pack B1.

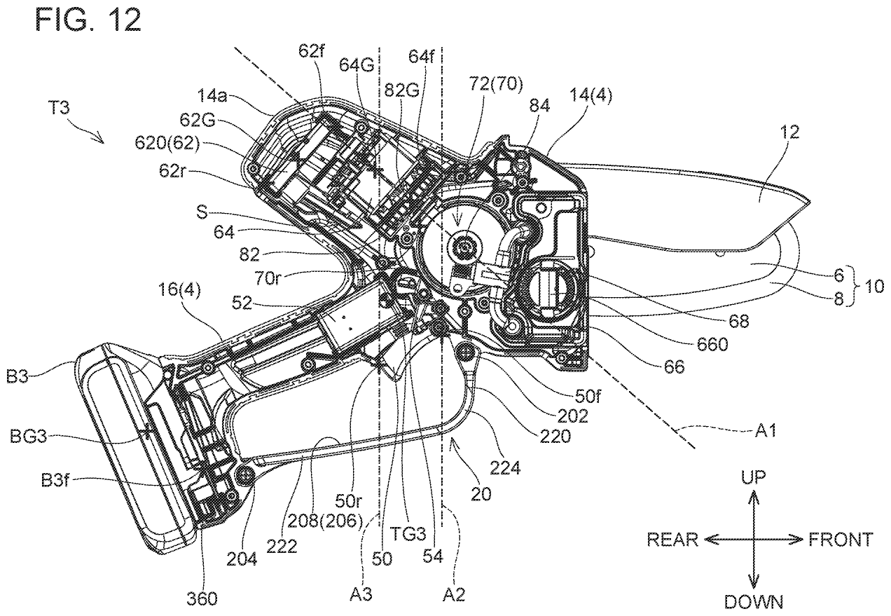

The battery pack B3 is configured to be attached to the battery interface 360 by sliding the battery pack B3 toward the front lower side from the rear upper side. Further, the battery interface 360 includes a connection terminal 362 for connecting with a terminal (not shown) of the battery pack B3. The connection terminal 362 is electrically connected with the control unit 62 (see FIG. 12) and the trigger switch 52 (see FIG. 12). When the battery pack B3 is attached to the battery interface 360, the terminal of the battery pack B3 and the connection terminal 362 are electrically connected. This allows electric power supply from the battery pack B3 to the control unit 62 and the trigger switch 52.

As shown in FIG. 12, when the battery pack B3 is attached to the battery interface 360, outer surfaces of the battery pack B3 and the grip 16 are smoothly connected. Further, the battery pack B3 is configured to be detached by sliding it toward the rear upper side from the front lower side with respect to the battery interface 360 with a hook 364 arranged on the battery pack B3 pressed in (see FIG. 11).

A front end B3f and a position of gravity center BG3 of the battery pack B3 are disposed rearward of the rear end 50r of the trigger lever 50. Further, a position of gravity center TG3 of the chainsaw T3 is inside the housing 4 and disposed between the straight lines A2 and A3. The position of gravity center TG3 can be said as being located in proximity to a front end of the trigger switch 52. Further, a distance from the straight line A2 to the position of gravity center TG3 is larger than a distance from the straight line A3 to the position of gravity center TG3. In the present embodiment, the position of gravity center TG3 of the chainsaw T3 is located substantially at the same position as the gravity center of the TG2 of the chainsaw T2 of the second embodiment.

### FOURTH EMBODIMENT

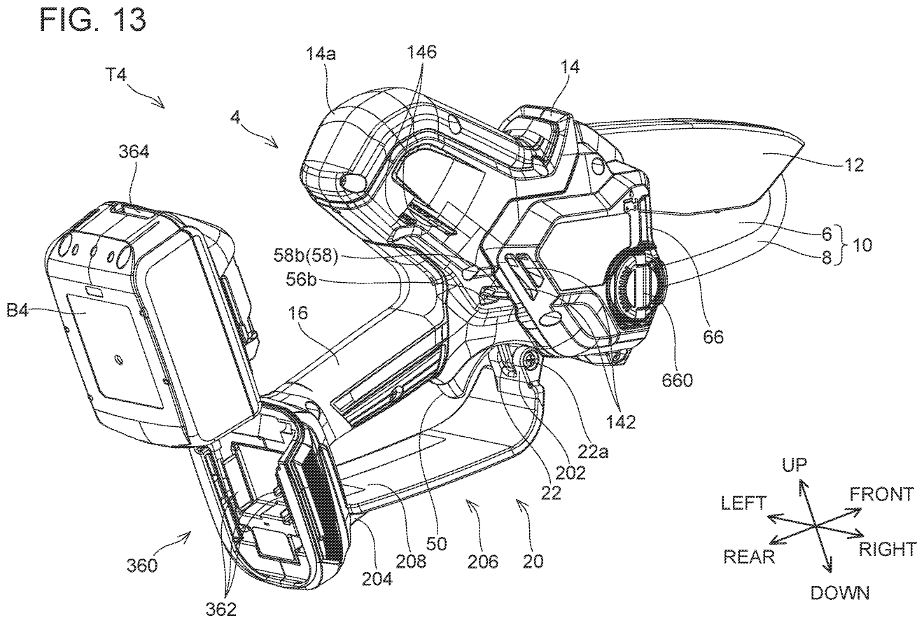

As shown in FIG. 13, a working machine of the present embodiment is a chainsaw T4. The chainsaw T4 has substantially the same configuration as the chainsaw T3 of the third embodiment except that it comprises a battery pack B4 instead of the battery pack B3. Hereinbelow, explanation will be given only on the differences between the chainsaw T4 and the chainsaw T3.

The battery pack B4 houses a rechargeable secondary battery such as a lithium ion battery. An output voltage of the battery pack B4 may for example be 18V. A battery capacity of the battery pack B4 may for example be 6.0 Ah. Weight of the battery pack B4 may for example be about 670 grams. Similar to the battery pack B3, the battery pack B4 is configured to be detachably attached to the battery interface 360.

As compared to the battery pack B3 (see FIG. 11), the battery pack B4 has a wider width in the extending direction of the grip 16. A width of the battery pack B4 in the left-right direction is about the same as that of the battery pack B3. A width of the battery pack B4 in the direction perpendicular to the extending direction of the grip 16 and the left-right direction is about the same as that of the battery pack B3. Due to this, a volume of the battery pack B4 is larger than the volume of the battery pack B3.

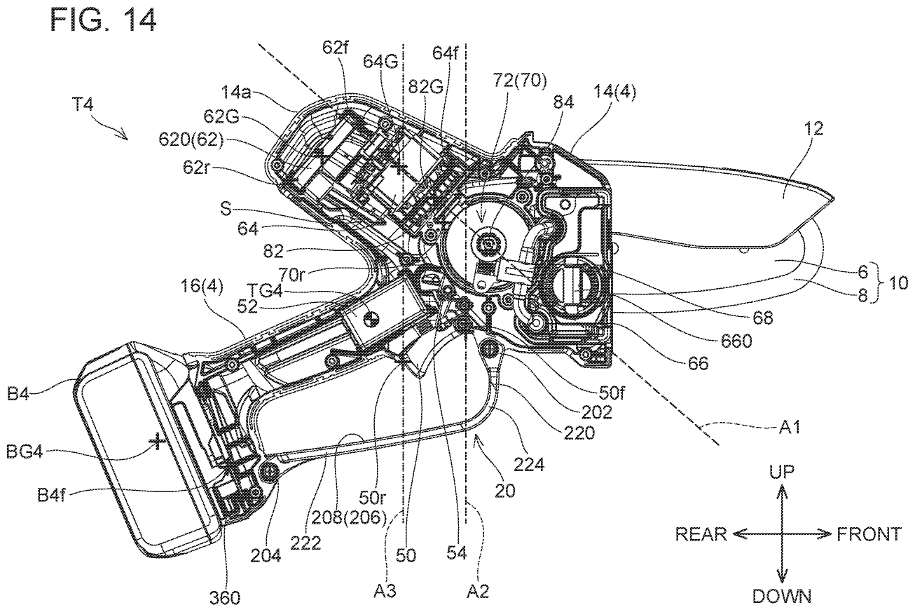

As shown in FIG. 14, a front end B4f and a position of gravity center BG4 of the battery pack B4 are disposed rearward of the rear end 50r of the trigger lever 50. Further, a position of gravity center TG4 of the chainsaw T4 is disposed inside the housing 4 and rearward of the straight line A3. The position of gravity center TG4 can also be said as being located in proximity to a rear end of the trigger switch 52.

Hereinbelow, the chainsaw T1, the chainsaw T2, the chainsaw T3, and the chainsaw T4 may collectively be termed “chainsaw T”.

(Variants)

In the above embodiments, examples in which the working machine is the chainsaw T that comprises the guide bar 6 and the saw chain 8 as the working unit 10 have been explained. In another embodiment, the working machine may be a reciprocating saw including a saw blade as its working unit 10. When the working machine is a reciprocating saw, the working machine may not comprise the oil tank 66 and the oil pump 68.

In the above embodiments, the configurations in which the chainsaw T is a pruning chainsaw that is expected to be carried by one hand have been explained. In another embodiment, the chainsaw T may be a large-sized chainsaw with a handle to be grasped by a hand different from the hand grasping the grip (corresponding to the grip 16), that is, a chainsaw that is expected to be carried by both hands. In this case, the handle to be grasped by the other hand may be disposed at an upper portion of its housing (corresponding to the housing 4) or may be disposed on a lateral side of the housing.

In the above embodiments, the configurations in which the electric motor 64 is the inner rotor DC brushless motor have been explained. In another embodiment, the electric motor 64 may be an outer rotor DC brushless motor. Alternatively, the electric motor 64 may be a brush motor or another type of motor.

In the above embodiments, the configurations in which the housing 4 is constituted of plastic such as polyamide have been explained. In another embodiment, plastic other than polyamide with Young's modulus of 100 MPa or more (such as polycarbonate) may be used for the housing 4. Further, in yet another embodiment, the housing 4 may be constituted of a material (such as metal, aluminum in particular) other than plastic so long as the material has Young's modulus of 100 MPa or more.

In the above embodiments, the configurations in which the hand guard 20 is constituted of rubber such as nitrile butadiene rubber have been explained. In another embodiment, the hand guard 20 may be constituted of rubber other than nitrile butadiene rubber (such as ethylene propylene rubber) so long as this material has Young's modulus within a range from 1 MPa to 100 MPa.

In the above embodiments, at least one of the first end 202 and the second end 204 of the hand guard 20 may be attached to its corresponding one of the first attachment portion 22 and the second attachment portion 24 in a state not being able to rotate with respect to the attached one of the first attachment portion 22 and the second attachment portion 24.

In the above embodiments, the plurality of rib portions 210 of the hand guard 20 may not comprise at least one (rib group) of the first rib portions 212, the second rib portions 214, and the third rib portion 216. That is, one group of the three rib groups, namely, the first rib portions 212, the second rib portions 214, and the third rib portion 216 may be omitted from the plurality of rib portions 210.

In the above embodiments, the configurations in which the hand guard 20 is constituted of a material with relatively low Young's modulus (rubber) so that it deforms more easily than the housing 4 have been explained. In another embodiment, the hand guard 20 may be configured swingable with respect to the housing 4, that is, similar to a so-called swing door. In this case, when a load is applied to the hand guard 20 in a state where the hand guard 20 is in contact with an obstacle, the hand guard 20 deforms from a closed state to an open state. Further, in yet another embodiment, the hand guard 20 may be configured capable of sliding between a first position and a second position with respect to the housing 4. In this case, when a load is applied to the hand guard 20 in a state where the hand guard 20 is in contact with an obstacle, the hand guard 20 slides between the first and second positions, by which the position of the hand guard 20 with respect to the housing 4 changes. In cases where the hand guard 20 is configured to deform using a method other than the elastic deformation, the hand guard 20 may be constituted of a material other than rubber (such as plastic, polyamide in particular), and a material with Young's modulus of 100 MPa or more may be used.

In the above embodiments, the chainsaw T (an example of the working machine) may not comprise the transmission mechanism 70. In this case, for example, a plurality of teeth may be arranged on the sprocket 26, and these teeth of the sprocket 26 may mesh with the first bevel gear 72a fixed to the motor shaft 80. Further, the worm wheel 68a of the oil pump 68 may mesh with the first bevel gear 72a fixed to the motor shaft 80.

In the above embodiments, the configurations in which metal such as aluminum is used for the controller case 620 have been explained. In another embodiment, the controller case 620 may be constituted of metal that is other than aluminum (such as iron). Further, in yet another embodiment, the controller case 620 may be constituted of a material other than metal (such as plastic, polyamide in particular).

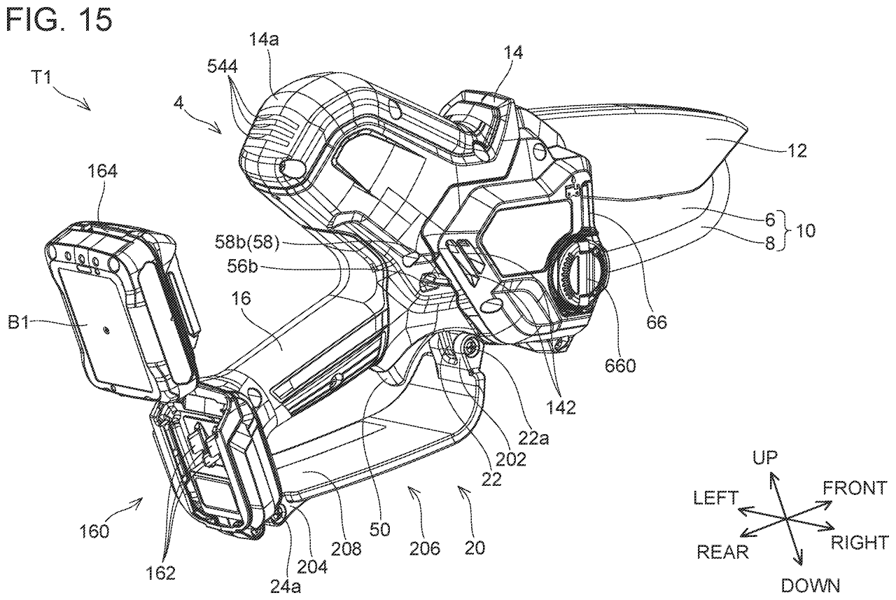

As shown in FIG. 15, the chainsaw T1 (an example of the working machine) may comprise an air outlet 544 instead of the air outlets 144, 146 in the above embodiments. The air outlet 544 is disposed at the top portion 14a of the housing body 14. In this case, when the cooling fan 82 rotates, the air within the housing 4 is discharged to the outside through the air outlet 544 instead of the air outlets 144, 146. In this case as well, the cooling fan 82 can cool the electric motor 64 as the electric motor 64 is driven. The above configuration may be applied to any of chainsaws T2, T3, and T4.

(Correspondence Relationship)

As described above, in one or more embodiments, the chainsaw T (an example of the working machine) may comprise a working unit 10 having a longitudinal direction in a front-back direction, an electric motor 64 configured to drive the working unit 10, a control unit 62 configured to control the electric motor 64, a housing 4 including a housing body 14 and a grip 16, wherein the housing body 14 holds the working unit 10 and houses the electric motor 64 and the control unit 62, and the grip 16 extends from the housing body 14 and is configured to be grasped by a user's hand, a battery pack B1 (or battery pack B2, B3, B4) attached to the housing 4 and configured to supply electric power to the electric motor 64 via the control unit 62, and a trigger lever 50 disposed on the grip 16 and configured to operate the electric motor 64 by being pulled toward the grip 16 by a finger of the user. A front end 62f of the control unit 62 may be disposed rearward of a rear end 50r of the trigger lever 50.

In view of user safety, the grip 16 which the user grasps is generally disposed at a position distant from the working unit 10 (such as on a rear portion of the chainsaw T). Further, it is also norm that weight of a working unit 10 with respect to the entire chainsaw T is relatively large. Due to this, the chainsaw T is likely to have a heavy object (such as the working unit 10) placed frontward of the front end 50f of the trigger lever 50, and moment generated with the front end 50f of the trigger lever 50 as a fulcrum tends to be large. Since an area at or in proximity to the front end 50f of the trigger lever 50 is a portion where the user places finger(s), when the moment generated with the front end 50f of the trigger lever 50 as the fulcrum is large, handling performance of the chainsaw T is decreased. Contrary to this, according to the above configuration, the front end 62f of the control unit 62 having relatively large weight among constituent components of the chainsaw T is disposed rearward of the rear end 50r of the trigger lever 50. Due to this, the moment generated with the front end 50f of the trigger lever 50 as the fulcrum can be reduced by the weight of the control unit 62. Thus, the handling performance of the chainsaw T can be improved.

In one or more embodiments, the gravity center 64G of the electric motor 64 is disposed rearward of the rear end 50r of the trigger lever 50.

The electric motor 64 is also a component with relatively large weight among the constituent components of the chainsaw T. According to the above configuration, the position of gravity center 64G of the electric motor 64 is disposed rearward of the rear end 50r of the trigger lever 50. Due to this, the moment generated with the front end 50f of the trigger lever as the fulcrum can be reduced by the weight of the electric motor 64. Thus, the handling performance of the chainsaw T can further be improved.

In one or more embodiments, the front end 64f of the electric motor 64 is disposed rearward of the front end 50f of the trigger lever 50.

According to the above configuration, the moment generated with the front end 50f of the trigger lever 50 as the fulcrum can further be reduced by the weight of the electric motor 64. Thus, the handling performance of the chainsaw T can further be improved.

In one or more embodiments, the front end B if of the battery pack B1 (or the front end B2f of the battery pack B2, the front end B3f of the battery pack B3, the front end B4f of the battery pack B4) is disposed rearward of the rear end 50r of the trigger lever 50.

The battery pack B1 (or the battery pack B2, B3, B4) is also a component with relatively large weight among the constituent components of the chainsaw T. According to the above configuration, the front end B if of the battery pack B1 (or the front end B2f of the battery pack B2, the front end B3f of the battery pack B3, the front end B4f of the battery pack B4) is disposed rearward of the rear end 50r of the trigger lever 50. Due to this, the moment generated with the front end 50f of the trigger lever 50 as the fulcrum can be reduced by the weight of the battery pack B1 (or the battery pack B2, B3, B4). Thus, the handling performance of the chainsaw T can further be improved.

In one or more embodiments, the chainsaw T further comprises the transmission mechanism 70 housed in the housing body 14 and configured to transmit power from the electric motor 64 to the working unit 10. The rear end 70r of the transmission mechanism 70 is disposed rearward of the front end 50f of the trigger lever 50.

In the chainsaw T, the transmission mechanism 70 (including the reduction gear 72, etc.) is disposed between the electric motor 64 and the working unit 10. The transmission mechanism 70 is also a component with relatively large weight among the constituent components of the chainsaw T. According to the above configuration, the rear end 70r of the transmission mechanism 70 is disposed rearward of the front end 50f of the trigger lever 50. Due to this, the moment generated with the front end 50f of the trigger lever 50 as the fulcrum can be reduced by the weight at and in proximity to the rear end 70r of the transmission mechanism 70. Thus, the handling performance of the chainsaw T can further be improved.

In one or more embodiments, the control unit 62 comprises the control board (not shown) configured to control the electric motor 64 and the controller case 620 that houses the control board. The controller case 620 is constituted of a metal.

In the chainsaw T, metal may be used for the controller case 620 for the purpose of improving cooling efficiency for the control board. Since metal has relatively large specific gravity, when the controller case 620 is constituted of metal, weight of the control unit 62 thereby increases. That is, the position of the control unit 62 becomes a greater affecting factor to the moment generated with the front end 50f of the trigger lever 50 as the fulcrum. According to the above configuration, the controller case 620 is constituted of metal. Due to this, the cooling efficiency for the control board can be improved. Further, according to the above configuration, moment reduction effect achieved by the arrangement of the control unit 62 becomes more prominent. Thus, improving effect for the handling performance of the chainsaw T achieved by the present application becomes more prominent.

In one or more embodiments, the electric motor 64 is a brushless motor. The control unit 62 comprises a switching element configured to control current supplied to the electric motor 64.

Generally, when the electric motor 64 is a brushless motor, a generated quantity of heat in the control unit 62 becomes relatively large by heat generation of a plurality of switching elements. In this case, in order to efficiently cool the control unit 62, the need to constitute the controller case 620 with metal becomes higher. Further, as discussed above, when the controller case 620 is constituted of metal, the improving effect for the handling performance of the chainsaw T achieved by the present application becomes more prominent. According to the above configuration, since the electric motor 64 is a brushless motor, metal is highly likely used to constitute the controller case 620. Thus, the improving effect for the handling performance of the chainsaw T achieved by the present application is highly likely achieved more prominently.

In one or more embodiments, the working unit 10 comprises the guide bar 6 extending in the front-back direction and the saw chain 8 disposed on the periphery of the guide bar 6 and configured to move along the periphery of the guide bar 6 as the electric motor 64 operates. The working machine works as the chainsaw T.

According to the above configuration, handling performance of the chainsaw T can be improved.

In one or more embodiments, the chainsaw T further comprises the oil tank 66 attached to the housing body 14 and configured to store lubricating oil for lubricating the saw chain 8. The oil tank 66 is arranged in proximity to the front end of the housing body 14.

In the chainsaw T, lubricant oil stored in the oil tank 66 needs to be supplied to the saw chain 8 (or guide bar 6) to lubricate the saw chain 8. In doing so, when a distance between the oil tank 66 and the saw chain 8 (or guide bar 6) is large, the oil supply path 682 (an example of supply path of the lubricant oil from the oil tank to the saw chain or guide bar) becomes longer, and this may lead to a size increase of the chainsaw T. Contrary to this, according to the above configuration, the oil tank 66 is disposed in proximity to the front end of the housing body 14, that is, in proximity to the saw chain 8 (or guide bar 6). Thus, the oil supply path 682 can be designed short, and the chainsaw T can be designed compact.

In one or more embodiments, the electric motor 64 comprises the stator 76 and the rotor 78. The chainsaw T further comprises the motor shaft 80 fixed to the rotor 78. The axis line A1 of the motor shaft 80 is disposed on the plane extending along the front-back and up-down directions. The control unit 62 is disposed on the axis line A1 of the motor shaft 80.

According to the above configuration, the distance between the control unit 62 and the electric motor 64 can be shortened. Due to this, a length of a conductor for electrically connecting the control unit 62 and the electric motor 64 can be set short. Thus, the chainsaw T can be designed compact.

In one or more embodiments, the distance from the axis line A1 to the front end 62f of the control unit 62 is smaller than the distance from the axis line A1 to the rear end 62r of the control unit 62.

Generally, the electric motor 64 has a substantially axisymmetric shape with respect to the axis line A1 of the motor shaft 80. According to the above configuration, a center position of the control unit 62 in the front-back direction can be offset rearward along the radial direction of the axis line A1. Due to this, in the radial direction of the axis line A1, the center position of the control unit 62 can be offset rearward with respect to the center position of the electric motor 64. By configuring as such, the conductor for electrically connecting the control unit 62 and the electric motor 64 can easily be disposed rearward of the electric motor 64. That is, the position of the conductor relative to the trigger lever 50 can easily be disposed farther rearward. The conductor disposed rearward of the electric motor 64 is disposed rearward of the rear end 50r of the trigger lever 50. In this case, the moment generated with the front end of the trigger lever 50 as the fulcrum can be reduced by the weight of the conductor. Thus, the handling performance of the chainsaw T can further be improved.

In one or more embodiments, when inside of the housing body 14 is seen from front along the direction perpendicular to the axis line A1 of the motor shaft 80, the control unit 62, the electric motor 64, and the oil tank 66 are arranged substantially in a line.

According to the above configuration, the housing body 14 can be designed compact in the radial direction of the axis line A1. That is, the chainsaw T can be designed compact in the radial direction of the axis line A1.

What is claimed is:

1. A working machine comprising:
a working unit having a longitudinal direction in a front-back direction;
an electric motor configured to drive the working unit;
a control unit configured to control the electric motor;
a housing including a housing body and a grip, wherein the housing body holds the working unit and houses the electric motor and the control unit and the grip extends from the housing body and is configured to be grasped by a user's hand;
a battery pack attached to the housing and configured to supply electric power to the electric motor via the control unit; and
a trigger lever disposed on the grip and configured to operate the electric motor by being pulled toward the grip by a finger of the user,
wherein
a front end of the control unit is disposed rearward of a rear end of the trigger lever.

2. The working machine according to claim 1, wherein
a center of gravity of the electric motor is disposed rearward of the rear end of the trigger lever.

3. The working machine according to claim 1, wherein
a front end of the electric motor is disposed rearward of a front end of the trigger lever.

4. The working machine according to claim 1, wherein
a front end of the battery pack is disposed rearward of the rear end of the trigger lever.

5. The working machine according to claim 1, further comprising a transmission mechanism housed in the housing body and configured to transmit power from the electric motor to the working unit,
wherein
a rear end of the transmission mechanism is disposed rearward of a front end of the trigger lever.

6. The working machine according to claim 1, wherein
the control unit comprises a control board configured to control the electric motor and a controller case that houses the control board, and
the controller case is constituted of a metal.

7. The working machine according to claim 1, wherein
the electric motor is a brushless motor, and
the control unit comprises a switching element configured to control current supplied to the electric motor.

8. The working machine according to claim 1, wherein
the working unit comprises a guide bar extending in the front-back direction and a saw chain disposed on a periphery of the guide bar and configured to move along the periphery of the guide bar as the electric motor operates, and
the working machine works as a chain saw.

9. The working machine according to claim 8, further comprising an oil tank attached to the housing body and configured to store lubricating oil for lubricating the saw chain,
wherein
the oil tank is arranged at or in proximity to a front end of the housing body.

10. The working machine according to claim 2, wherein
a front end of the electric motor is disposed rearward of a front end of the trigger lever,
a front end of the battery pack is disposed rearward of the rear end of the trigger lever,
the working machine further comprises a transmission mechanism housed in the housing body and configured to transmit power from the electric motor to the working unit,
a rear end of the transmission mechanism is disposed rearward of a front end of the trigger lever,
the control unit comprises a control board configured to control the electric motor and a controller case that houses the control board,
the controller case is constituted of a metal,
the electric motor is a brushless motor,
the control unit comprises a switching element configured to control current supplied to the electric motor,
the working unit comprises a guide bar extending in the front-back direction and a saw chain disposed on a periphery of the guide bar and configured to move along the periphery of the guide bar as the electric motor operates,
the working machine works as a chain saw,
the working machine further comprises an oil tank attached to the housing body and configured to store lubricating oil for lubricating the saw chain, and
the oil tank is arranged at or in proximity to a front end of the housing body.
